(19) United States
(12) Patent Application Publication
(10) Pub. No.: US 2016/0138953 A1
(43) Pub. Date: May 19, 2016

(54) LIQUID DISPENSER AND DISCHARGE HEAD FOR SAME

(71) Applicants: Juergen GREINER-PERTH, Gottmadingen (DE); Pia REY, Konstanz (DE)

(72) Inventors: Juergen GREINER-PERTH, Gottmadingen (DE); Pia REY, Konstanz (DE)

(21) Appl. No.: 14/886,310

(22) Filed: Oct. 19, 2015

(30) Foreign Application Priority Data
Nov. 18, 2014 (EP) 14193741.7

(51) Int. Cl. G01F 11/10; B67D 1/12; B67D 1/00

(52) U.S. Cl. CPC G01F 11/10; B67D 1/0001; B67D 1/1279

(57) ABSTRACT

A metering head for a liquid dispenser with a discharge opening for dispensing liquid from an interior of the metering head into an environment, a metering body and a metering channel within which the metering body is arranged movably between a closed position and an open position. The metering body is designed as a float and is adapted to the metering channel such that, during the movement in the direction of the closed position, liquid flowing to the discharge opening flows around it at least in phases. The metering body is adapted to the discharge opening such that, in its closed position, it closes the discharge opening off from the metering channel. The metering head also includes a ventilation channel separate from the discharge opening and having an inlet valve that opens when there is an underpressure in the metering channel in relation to the environment.

### CROSS-REFERENCE TO RELATED APPLICATIONS

This claims priority from European Application No. 14193741.7, filed on Nov. 18, 2014, the disclosure of which is hereby incorporated by reference in its entirety into this application.

### FIELD OF THE INVENTION

The invention relates to a metering head for a liquid dispenser, and to a liquid dispenser with such a metering head.

### BACKGROUND OF THE INVENTION

A liquid dispenser of the type in question and a corresponding metering head are known from EP 2 746 733 A1. Such dispensers of the type in question are, like dispensers according to the invention, suitable for metered dispensing of liquids of different viscosities. The main fields of use include those of dispensers for pharmaceutical liquids, for example cough sirup, for cosmetic liquids such as hair care and skin care products, and for foods such as dips, sauces, ketchup, mustard and the like.

The liquid dispensers of the type in question have a discharge opening for dispensing liquid, and a metering body, and a metering channel within which the metering body is arranged movably between a closed position and an open position.

The metering body is designed as a float, such that it assumes its open position, directed away from the discharge opening, when the liquid dispenser is in an upended position in which the discharge opening faces downward. When pressure is applied to the liquid, the latter flows past the metering body in the direction of the discharge opening and in so doing moves the metering body counter to the lifting force in the direction of the closed position directed toward the discharge opening. In the closed position, the metering body prevents further flow of liquid to the discharge opening and thus terminates the discharge procedure.

Dispensers of the type in question are accordingly intended to discharge an at least approximately constant amount of liquid by means of pressure being applied to the liquid when the dispenser is in an upended position, by means of which pressure the metering body, located in the open position as a result of the lifting force, is moved in the direction of the discharge opening and thus in the direction of its closed position. The length of time the metering body needs to do this is linked sufficiently precisely to the discharged amount of liquid, such that a liquid dispenser of the type in question can ensure the discharge of approximately constant volumes of liquid per discharge procedure.

The dispenser of this type known from EP 2 746 733 A1 uses its discharge opening also as a ventilation opening in order to be able to achieve pressure equalization inside a liquid reservoir of the dispenser after a discharge procedure. With an underpressure inside the dispenser, air is sucked in through the discharge opening.

It was found that this procedure requires improvement. Since the discharge opening of a dispenser of the type in question is usually arranged centrally with respect to the direction of movement of the metering body and since the discharge opening, in the end position of the metering body, is intended to bear sealingly in the area of the discharge opening, a situation can arise where, although air is sucked in through the discharge opening after a discharge procedure, it however collects at the front face of the metering body instead of flowing past the latter and together with the buoyant force thereby returning the metering body to the open position. A further disadvantage of the known design is that it is necessary to provide a discharge opening without a valve or to use only a weak valve that allows air to flow in when there is an underpressure in the metering channel. Both of these disadvantages can lead to the dispenser tending to leak.

### SUMMARY OF THE INVENTION

The problem addressed by the invention is to develop a dispenser of the type in question in such a way that it overcomes or alleviates the stated disadvantages of the prior art.

According to the invention, this is achieved by the fact that the metering head comprises at least one ventilation channel separate from the discharge opening. This ventilation channel has an inlet valve which opens the metering channel to the environment when there is an underpressure.

The metering head according to the invention thus has one or more discharge openings through which liquid can be dispensed from an interior of the dispenser provided with the metering head, until the metering body inside the metering channel has been moved as far as its closed position by the liquid flowing in the direction of the discharge opening. For this purpose, the metering channel and the metering body are adapted to each other such that, with the overpressure created in the dispenser by the actuation thereof, the liquid flowing past the metering body moves the latter counter to its lifting force. The metering channel can be closed about its periphery or can also be partially open. It can in particular also be formed in parts by a bottle neck of the dispenser. The metering head has abutments which define the closed position and the opposite open position of the metering body in the metering channel.

To ensure that the metering body assumes its open position before the start of the discharge procedure, it is designed as a float. This means that it has a lower density than the liquid to be discharged. If a liquid is to be discharged whose density is equal to that of water, the float should thus have a density of <1 g/cm³. However, depending on the liquid to be dispensed, the density of the float can also be greater, as long as it is sufficiently low to allow it to float on the liquid to be discharged.

In the closed position directed toward the discharge opening, the metering body closes the discharge opening, which does not have to involve direct closure of the inner inlet of the discharge opening but also entails closing the discharge opening by forming an isolation area remaining between the discharge opening and the metering body. It is essential that the discharge opening is closed with respect to the part of the metering channel remaining on the other side of the metering body and in particular with respect to the liquid reservoir.

The use of a separate ventilation channel is suitable to promote the return of the metering body from its closed position in the direction of its open position. By virtue of the preferably eccentric arrangement of the ventilation channel and in particular preferably of the several ventilation channels with respect to the discharge opening, incoming air tends to flow toward edge areas of the metering body, which increases the tendency of the latter to leave the closed position. However, to ensure that the discharge takes place reliably through the discharge opening, the at least one ventilation channel is assigned an inlet valve which closes during the discharge procedure and which is opened when there is an underpressure in the metering channel as a result of the return movement of the metering body in the direction of its open position.

The separate ventilation channel affords the advantage that the air does not have to flow into the intentionally isolated area formed by the metering body and instead it can flow directly into the area not isolated from the metering channel.

The use of a separate ventilation channel is also particularly advantageous if the discharge opening is assigned an outlet valve. Since no air has to be sucked into the dispenser, on which the metering head is provided, through the discharge opening, it is possible here to use an outlet valve which opens when there is an overpressure in the metering channel in relation to the environment and which particularly preferably is closed when there is an approximately identical pressure inside the dispenser and in the environment. Such an outlet valve effectively prevents leakage from the dispenser.

As regards both the inlet valve and also the outlet valve, these preferably have an elastically deformable valve face which, in the relaxed state, bears on a valve seat and opens when subjected to pressure or which, in the relaxed state, is at a distance from a valve seat and, when subjected to pressure, is able to bear on the valve seat and closes the valve.

It is also considered advantageous if the outlet valve and the inlet valve each have elastically deformable valve faces which are designed integrally with each other. This makes it possible to provide both the function of the outlet valve and also the function of the inlet valve using just one component. This is not only relevant in terms of the number of components, it also makes assembly considerably easier. An advantageous option is one in which a valve body has an annular securing area which surrounds the valve face of the outlet valve and on the outside of which the valve face of the inlet valve is provided.

In principle, it is not essential that the ventilation channel is provided in direct proximity to the discharge opening. In the dispenser according to the invention, it can instead also be arranged in some other way, as long as it permits the flow of air from the environment into the liquid reservoir of the dispenser. However, it is considered advantageous if the metering body in its closed position delimits an isolation area which adjoins the discharge opening and which is separated by the metering body from the metering channel on the other side of the metering body. The ventilation channel preferably opens outside this isolation area, such that the air flowing in does not flow into the isolation area inside the metering head but flows past this. This promotes the release of the metering body from its end position directed toward the discharge opening.

It is particularly advantageous if the at least one ventilation channel, at its end directed away from the environment, opens out in such a way that incoming air on the path in the direction of the metering channel has to flow past the metering body. This is achieved in particular if the ventilation channel is provided directly adjacent to the discharge opening, such that air flowing in opens into the metering head located in the upended position in such a way that the air, ascending in the direction of the liquid reservoir, necessarily impacts the metering body or flows around it.

The reliability of the separation of the metering body from a corresponding sealing surface in arrangement of the closed position is further improved if the metering head comprises a plurality of ventilation channels that each have an inlet valve. It is particularly advantageous if the ventilation channels are arranged on opposite sides with respect to the center axis of the metering body and preferably with respect to the discharge opening lying on this center axis. If more than two ventilation channels are used, these preferably open out on a circular trajectory surrounding the center axis and/or the discharge opening.

The use of several ventilation channels is also advantageous in terms of the return movement of the metering body, since the latter is in this way subjected uniformly to force by the air that flows in. This is further improved if more than two ventilation channels open into the isolation area between the discharge opening and the metering body located in the closed position.

Also in the case of more than one ventilation channel with inlet valve, it is advantageous if several valves are configured at least partially in one piece. Thus, the inlet valves of several ventilation channels can each be designed with deformable valve faces which are contiguous with each other and thus easier to produce and to assemble. In particular, elastically deformable valve faces of the outlet valve on the one hand and of several inlet valves on the other hand can be configured in one piece. Possible materials for the elastic valve faces are the elastically deformable plastics typically used in the valve area. It is also possible here to use rubber, and other kinds of materials that meet the requirements of elastic deformability and leaktightness.

If several ventilation channels are provided, it can also be advantageous to provide a common valve face that closes the several ventilation channels jointly. Thus, a particularly advantageous configuration is one in which several inlet valves arranged in a circle can be closed by a common valve face, which is secured on an inner or outer holding area. This valve face can span the mouths of the different ventilation channels like an umbrella and, when there is an underpresure in the dispenser, can detach itself from these mouths. This promotes a homogeneous inflow of air and, as a result of this, a particularly smooth operation.

The metering head according to the invention is intended to be used as part of a liquid dispenser which, in addition to the metering head, also comprises a liquid reservoir for receiving liquid that is to be dispensed.

The metering head can be secured, as a separate and independently functional unit, on a -liquid reservoir. However, it is particularly advantageous if the metering head is connected at least partially integrally to the liquid reservoir. Thus, in particular, a wall of the liquid reservoir in the area of the bottle neck of the dispenser can at the same time represent a wall of the metering channel.

The specific density of the metering body is adapted to the liquid to be used in this liquid dispenser, in such a way that the desired behavior as a float is achieved.

A liquid dispenser whose liquid reservoir is designed as a squeeze bottle is considered particularly advantageous. Such a squeeze bottle is distinguished by the fact that it has walls that can be sufficiently deformed or moved relative to each other when force is applied firmly by an adult, in order to reduce the internal volume of the liquid reservoir, for the purpose of discharge, and in order to return it automatically to its starting position after the force ceases to be applied.

### BRIEF DESCRIPTION OF THE DRAWINGS

Further aspects and advantages of the invention will become clear from the claims and from the following description of an exemplary embodiment of the invention. In the drawing:

FIG. 1 shows a dispenser according to the invention in an overall sectional view.

FIG. 2 shows the dispenser from FIG. 1 in a plan view, and

FIGS. 3A-3D show the dispenser from FIGS. 1 and 2 during a discharge procedure.

### DETAILED DESCRIPTION

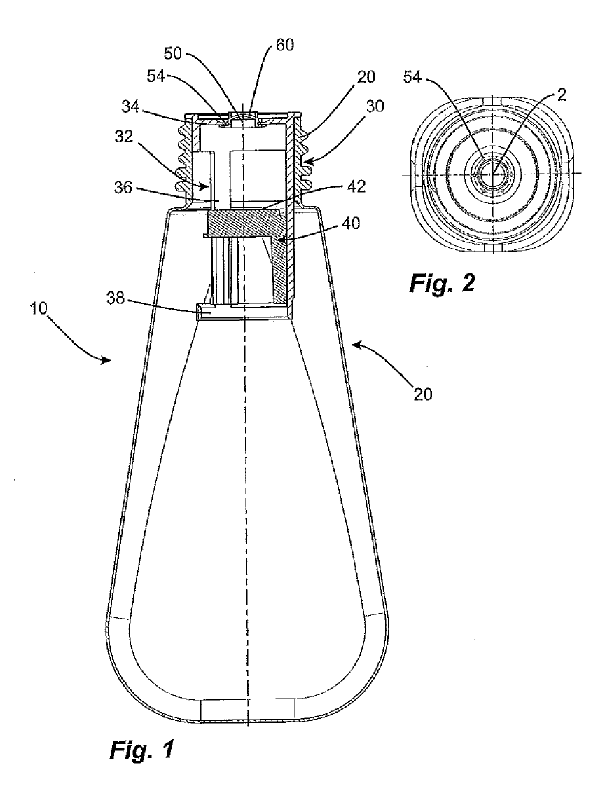

FIG. 1 shows a liquid dispenser 10 according to the invention in a sectional view. This dispenser 10 has a squeeze bottle 20 for accommodating liquid prior to its being discharged, in particular pharmaceutical liquids. The dispenser is used in particular for those liquids in which the metered dispensing usually takes place into a separate container such as a cup. A typical use of such a dispenser is for cough sirup and the like.

The upper end of the liquid reservoir is adjoined by a metering head 30. This metering head is delimited on the outside in particular by a bottle neck 22 of the liquid reservoir 20, into which a cage 32 is inserted which, together with the bottle neck 22, forms the main components of a metering channel. The cage 32 has a front face 34, and also struts 36 which extend from the front face into the liquid reservoir 20 and, at their lower end with respect to FIG. 1, are connected to one another by a ring 38.

A metering body 40 is fitted in the cage 32. This metering body has an approximately cylindrical basic shape with a plane bearing face 42 directed toward the discharge opening. The metering body 40 is movable in the direction of an arrow 4 between two end positions. The end position that the metering body 40 adopts in FIG. 1 is designated here as the open position.

The front face 34 of the cage 32 has a large central aperture 50, and a multiplicity of smaller apertures 54 arranged in a circle around a center axis 2, as can be seen also from the plan view in FIG. 2. It will be noted here that the apertures 54 lie on a circular trajectory surrounding the discharge opening and the center axis 2.

The central aperture 50 is part of an outlet channel. The smaller apertures 54 are each part of ventilation channels. An elastic valve component 60, inserted into the central aperture 50, has a peripheral holding area 62 and, to the inside of the holding area, interacting valve flaps 64, which together form a slit valve. To the outside of the holding area 62, a peripheral valve face 66 like an umbrella is provided which covers the smaller apertures 54.

If there is no pressure difference between an interior of the dispenser 10 and an environment, the valve faces 64 bear on one another in such a way that the discharge opening formed by them is closed. At these pressure conditions, the umbrella-like valve face 66 moreover bears on the inner side of the front face 34 in such a way that the apertures 54 forming the ventilation channels are also tightly closed. Therefore, in this state in FIG. 1, there is no danger of undesired leakage from the dispenser, even when the latter is placed upside down.

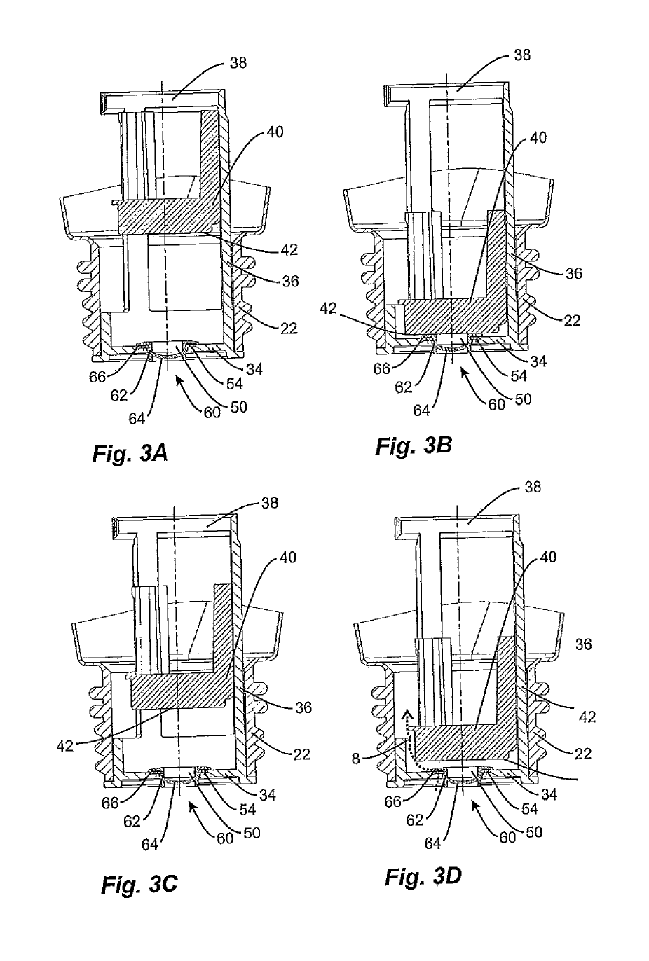

For its intended use, the dispenser 20 is placed in an upside down position as shown in FIGS. 3A to 3D.

Since the metering body 40 is designed as a float and, for this purpose, has a density lower than that of the liquid to be discharged, it assumes the end position shown in FIG. 3A when the dispenser has been placed in the upside down position. It is located in its open position directed away from the discharge opening.

If pressure is now applied to the liquid in the liquid reservoir 20 by pressing the walls together, the outlet valve formed by the valve faces 64 opens on account of this overpressure. The liquid moving to the discharge opening flows past the metering head 40 and carries the latter along counter to the lifting force.

FIG. 3B shows the dispenser during the discharge procedure. The continued movement of the metering body 40 in the direction of the discharge opening ends when the metering body 40 has reached its end position at the discharge opening, i.e. the closed position. It bears here with its front face 42 on the inner side of the valve component 60 and thus closes the access of liquid from the liquid reservoir 20 to the discharge channel. The discharge procedure is terminated. This state is shown in FIG. 3C.

To prepare the dispenser for a renewed discharge procedure, the force applied to the squeeze bottle 20 is terminated, as a result of which an underpressure develops therein, since the remaining amount of liquid is less than before the discharge procedure. This underpressure has the effect that the umbrella-like valve face 66 detaches itself from the ventilation apertures 54 and air is allowed to flow in from the environment. By virtue of the one-piece configuration of the valve face 66, all the ventilation openings 54 are freed simultaneously. The incoming air flows past the metering body 40, in the manner shown by the arrow 8 in FIG. 3D, in the direction of the liquid reservoir 20. In this way, the valve body 40 is reliably separated from the valve component 60 and then, on account of the air flowing past and on account of its lower density, is brought back to the starting position, which is shown in FIG. 1 and in FIG. 3A.

In the configuration shown, the air flows in solely via the ventilation openings 54. By contrast, the valve faces 64, on account of their dome-shaped design, are of such a nature that the underpressure in the squeeze bottle keeps the valve formed by them closed, such that air does not flow in here.

After the metering body 40 has reached its starting position again, a renewed discharge procedure can begin.

1. A metering head for a liquid dispenser comprising:
a. at least one discharge opening for dispensing liquid from an interior of the metering head into an environment, and
b. a metering body, and a metering channel within which the metering body is arranged movably between a closed position and an open position, and
c. the metering body is designed as a float, and
d. the metering body is adapted to the metering channel in such a way that, during the movement in the direction of the closed position, liquid flowing to the discharge opening is able to flow around it at least in phases, and
e. the metering body is adapted to the discharge opening in such a way that, in its closed position, it closes the discharge opening off from the metering channel,
wherein:
f. the metering head comprises at least one ventilation channel which is separate from the discharge opening, and
g. the ventilation channel has an inlet valve that opens when there is an underpressure in the metering channel in relation to the environment.

2. The metering head as claimed in claim 1, wherein:
a. the discharge opening has an outlet valve that opens when there is an overpressure in the metering channel in relation to the environment.

3. The metering head as claimed in claim 2, wherein:
a. the outlet valve and the inlet valve have elastically deformable valve faces for the purposes of opening and closing, and
b. the valve faces of the outlet valve and of the inlet valve are formed integrally with each other.

4. The metering head as claimed in claim 1, wherein:
a. the metering body, in its closed position, delimits an isolation area which comprises the discharge opening and which is separated by the metering body from the metering channel, and
b. the at least one ventilation channel opens out, at its end directed away from the environment, outside the isolation area.

5. The metering head as claimed in claim 1, wherein:
a. the at least one ventilation channel opens out, at its end directed away from the environment, in such a way that incoming air on the path in the direction of the metering channel has to flow past the metering body.

6. The metering head as claimed in claim 1, wherein:
a. the at least one ventilation channel is arranged eccentrically with respect to a center axis of the metering body.

7. The metering head as claimed in claim 6, wherein:
a. the metering head comprises a plurality of ventilation channels which have an inlet valve that closes when there is an underpressure in the metering area in relation to the environment, and
b. the ventilation channels are arranged on opposite sides with respect to the center axis of the metering body or are arranged on a circular trajectory concentric to the center axis of the metering body.

8. A liquid dispenser comprising:
a liquid reservoir for accommodating liquid prior to its being dispensed, and
a metering head for dispensing the liquid, the metering head comprising:
at least one discharge opening for dispensing liquid from an interior of the metering head into an environment, and
a metering body, and a metering channel within which the metering body is arranged movably between a closed position and an open position, and
the metering body is designed as a float, and
the metering body is adapted to the metering channel in such a way that, during the movement in the direction of the closed position, liquid flowing to the discharge opening is able to flow around it at least in phases, and
the metering body is adapted to the discharge opening in such a way that, in its closed position, it closes the discharge opening off from the metering channel,
wherein:
the metering head comprises at least one ventilation channel which is separate from the discharge opening, and
the ventilation channel has an inlet valve that opens when there is an underpressure in the metering channel in relation to the environment.

9. The liquid dispenser as claimed in claim 8, wherein:
a. the liquid reservoir is designed as a squeeze bottle which, through deformation, allows pressure to be exerted on the liquid contained in it.
